(19) United States
(12) Patent Application Publication
(10) Pub. No.: US 2026/0203426 A1
(43) Pub. Date: Jul. 16, 2026

(54) SYSTEM AND METHOD FOR ZERO-TRUST APPLICATION PROGRAMMING INTERFACE SECURITY

(71) Applicant: ARIEL SCIENTIFIC INNOVATIONS LTD., Ariel (IL)

(72) Inventors: Ran DUBIN, Nordia (IL); Amit DVIR, Kefar Sava (IL)

(21) Appl. No.: 18/869,401

(22) PCT Filed: May 24, 2023
(86) PCT No.: PCT/IL2023/050539

§ 371 Date: Nov. 26, 2024

Related U.S. Application Data
(60) Provisional application No. 63/346,097, filed on May 26, 2022.

(51) Int. Cl. G06F 21/62

(52) U.S. Cl. CPC G06F 21/62

(57) ABSTRACT

A system and method of providing Application Programming Interface (API) security may include receiving an API documentation data element, describing one or more types of API requests; parsing the API documentation data element, to create one or more first schemes, each comprising one or more definitions for utilization of a corresponding API request type; receiving an API request to access a computing device on a protected computer network; associating a scheme of the one or more first schemes to the received API request, based on a type of the received API request; and filtering the received API request based on the associated first scheme.

### CROSS REFERENCE TO RELATED APPLICATIONS

This application claims the benefit of priority under 35 U.S.C. § 119(e) of U.S. Provisional Ser. No. 63/346,097 , filed May 26, 2022, entitled “SYSTEM AND METHOD FOR ZERO-TRUST APPLICATION PROGRAMMING INTERFACE SECURITY”. The contents of the above applications are all incorporated by reference as if fully set forth herein in their entirety.

### FIELD OF THE INVENTION

The present invention relates generally to systems and methods of cybersecurity. More specifically, the present invention relates to systems and methods for providing zero-trust Application Programming Interface (API) security.

### BACKGROUND OF THE INVENTION

Recent studies show that API cyber-attacks have become the most frequent vectors, or forms of cyber-attacks, causing data breaches for enterprise web applications. API attacks have been increasing at an alarming rate, with many well-publicized API security vulnerabilities already affecting a wide range of organizations. As a result, API security products have become one of the cyber-security industry's fastest growing branches.

Currently available solutions for API security employ signatures, anomaly detection algorithms, supervised and unsupervised Machine-Learning (ML) algorithms to ensure the legitimacy of data operations, authenticate and validation authorization of entities (e.g., users) to secure computing systems and data stored therein.

All these approaches depend on trust-based mechanisms that are adapted to acquire knowledge of attack vectors and/or detect anomalies in data access, to avoid exploitation of vulnerabilities and mitigate attack risk. Therefore, a protected organization needs to trust these mechanisms in order to maintain cyber-security. However, it may be appreciated that trust-based tools may lead to failure of cyber-security.

Additionally, currently available API security solutions are normally deployed as a gateway in a protected computer network, and are configured to determine whether to allow or block an API request based on existing trust-based security information. Such security mechanisms are typically generic, and are not designed or configured for a specific API (e.g., an API of a specific organizational website). Accordingly, such security mechanisms require a learning curve or rule-base system in order to adapt to ever-changing customer traffic. The duration of this learning curve typically depends on the specific characteristics of the organizational website and on the algorithms'sophistication level. It may be appreciated that an extensive duration of the learning curve may expose the protected computer network (e.g., organizational website) to a wide range of cyber-threats.

A Neural Network (NN) or an Artificial Neural Network (ANN), e.g., a neural network implementing a Machine Learning (ML) or Artificial Intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

As referred to herein, the term “web page” may refer to a document whose source code is typically written in plain text interspersed with formatting instructions of Hypertext Markup Language (HTML, XHTML) and optionally Cascade Style Sheets (CSS), which web page contains content such as text, images, video, audio, hyperlinks, etc.

As referred to herein, the term “web site” may refer to a set of related web pages. A web site is hosted on at least one web server, accessible via a network, such as the Internet or a private local area network, through an Internet address known as a Uniform Resource Locator (URL). Web pages of a web site are usually requested and served from a web server using an API such as a Hypertext Transfer Protocol (HTTP) API.

As referred to herein, the term “web browser” may refer to a software application for retrieving, interpreting, rendering, and presenting information resources from the World Wide Web or local servers. A web browser enables users to access and view documents and other resources on the Internet. Some of the major web browsers today are Google Chrome, Mozilla Firefox, Microsoft Internet Explorer, Opera, and Apple Safari.

### SUMMARY OF THE INVENTION

Embodiments of the invention may implement a novel, zero-trust approach to cyber security, which may limit an organizational computer network vulnerability to API attack vectors.

Embodiments of the invention may receive an API schema or API document such as an OpenAPI document (which is the de-facto standard for API documentation). The API document may represent one or more public API services that had been defined, implemented, and tested by developers who now require to minimize these API services' cyber-attack surface. The API schema or document may include a description or definition of API capabilities, API fields'structure, acceptable value types and acceptable values for the public API service.

As elaborated herein, embodiments of the invention may be configured to enforce limitations defined by the API document, by allowing only legitimate traffic that complies with these limitations.

In other words, embodiments of the invention may be configured to define a standard of data actions, based on the API schema or documentation, and block any form of data communication or action that deviates from this standard.

Additionally, or alternatively, embodiments of the invention may employ an unsupervised learning algorithm to automatically learn or determine one or more API structures or patterns, based on API traffic. Embodiments of the invention may subsequently enforce limitations on API actions and communication according to the determined API structures.

Embodiments of the invention may include a method of providing API security by at least one processor. Embodiments of the method may include receiving an API documentation data element, describing one or more types of API requests, and parsing the API documentation data element, to create one or more first schemes, where at least one (e.g., each) of the first schemes may include one or more definitions for utilization of a corresponding API request type. Embodiments of the method may further include receiving an API request to access a computing device on a protected computer network; associating a scheme of the one or more first schemes to the received API request, based on a type of the received API request; and filtering the received API request based on the associated first scheme.

According to some embodiments, the definition for utilization of an API request type may include definitions of one or more fields of the API request type and/or one or more applicable values of these fields.

Embodiments of the method may further include attributing one or more filtration actions to at least one API request type. Filtering the received API request may include applying the one or more filtration actions to the received API request, based on the associated scheme.

For example, the filtration actions may include transferring the API request to the computing device of the protected computer network, blocking the received API request, disarming the received API request, reconstructing the received API request, transferring a response of the computing device of the protected computer network to the received API request, blocking the response of the computing device of the protected computer network to the received API request, disarming a response of the computing device of the protected computer network to the received API request, reconstructing a response of the computing device of the protected computer network to the received API request, producing an alert (e.g., in relation to a blocked API request and/or API response), and the like.

Embodiments of the method may further include applying a machine-learning (ML) based model on the received API request, to obtain at least one second utilization scheme, which may include one or more definitions for utilization of fields of the received API request. Embodiments may subsequently filter the received API request according to the second utilization scheme.

Embodiments of the method may, during a training stage, receive a plurality of API requests, corresponding to a respective plurality of API request types. For at least one API request type, Embodiments of the invention may train the ML model to cluster the corresponding plurality of API requests to one or more clusters, based on content of fields of the API requests. For at least one cluster, embodiments of the invention may associate a second utilization scheme that includes one or more definitions for utilization of fields of the corresponding API requests.

According to some embodiments, filtering the received API request according to the second utilization scheme may include associating one or more filtration actions to at least one cluster; identifying a condition in which the received API request is non-compliant with a second utilization scheme of the at least one cluster; and applying the one or more filtration actions on the received API request, based on the identification.

Embodiments of the invention may include a method of providing API security by at least one processor. Embodiments of the method may include receiving an API request; applying an ML based model on the API request, to obtain a utilization scheme that includes one or more definitions for content of fields of the received API request; and filtering the received API request according to the utilization scheme.

During a training stage, embodiments of the invention may receive a plurality of API requests, corresponding to a respective plurality of API request types. For at least one API request type, embodiments of the invention may train the ML model to cluster the corresponding plurality of API requests to one or more clusters, based on content of fields of the API requests. For at least one cluster, embodiments of the invention may associate a utilization scheme that includes one or more definitions for utilization of fields of the corresponding API requests.

According to some embodiments, filtering the received API request according to the utilization scheme may include associating one or more filtration actions to at least one cluster; identifying a condition in which the received API request is non-compliant with a utilization scheme of the at least one cluster; and applying the one or more filtration actions on the received API request, based on said identification.

Embodiments of the invention may include a system for providing zero-trust API security, the system may include: a non-transitory memory device, wherein modules of instruction code are stored, and a processor associated with the memory device, and configured to execute the modules of instruction code. Upon execution of the modules of instruction code, the processor may be configured to: receive an API documentation data element, describing one or more types of API requests; parse the API documentation data element, to create one or more first schemes, each may include one or more definitions for utilization of a corresponding API request type; receive an API request to access a computing device on a protected computer network; associate a scheme of the one or more first schemes to the received API request, based on a type of the received API request; and filter the received API request based on the associated first scheme.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for providing zero-trust API security, according to some embodiments;

FIG. 2A is a block diagram, depicting application of a system for providing zero-trust API security, according to some embodiments;

FIG. 2B is a schematic diagram depicting a visualization of content of an API documentation data element, as known in the art;

FIG. 3 is a block diagram, depicting a system for providing zero-trust API security, according to some embodiments;

FIG. 4 is a block diagram, depicting an aspect of a system for providing zero-trust API security, according to some embodiments;

FIG. 5 is a block diagram, depicting another aspect of a system for providing zero-trust API security, according to some embodiments; and

FIG. 6 is a flow diagram, depicting a method of providing zero-trust API security, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

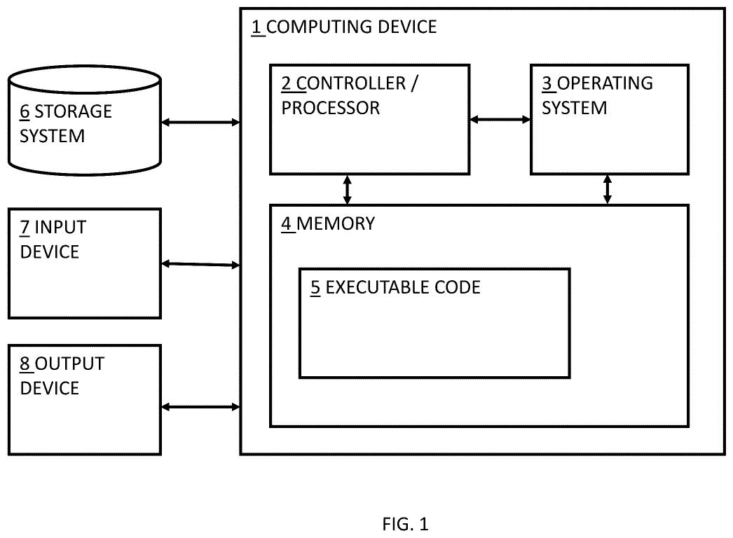

Reference is now made to FIG. 1, which is a block diagram depicting a computing device, which may be included within an embodiment of a system for providing zero-trust API security, according to some embodiments of the invention.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a Read Only Memory (ROM), a Dynamic RAM (DRAM), a Synchronous DRAM (SD-RAM), a Double Data Rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may provide zero-trust API security, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to zero-trust API security may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

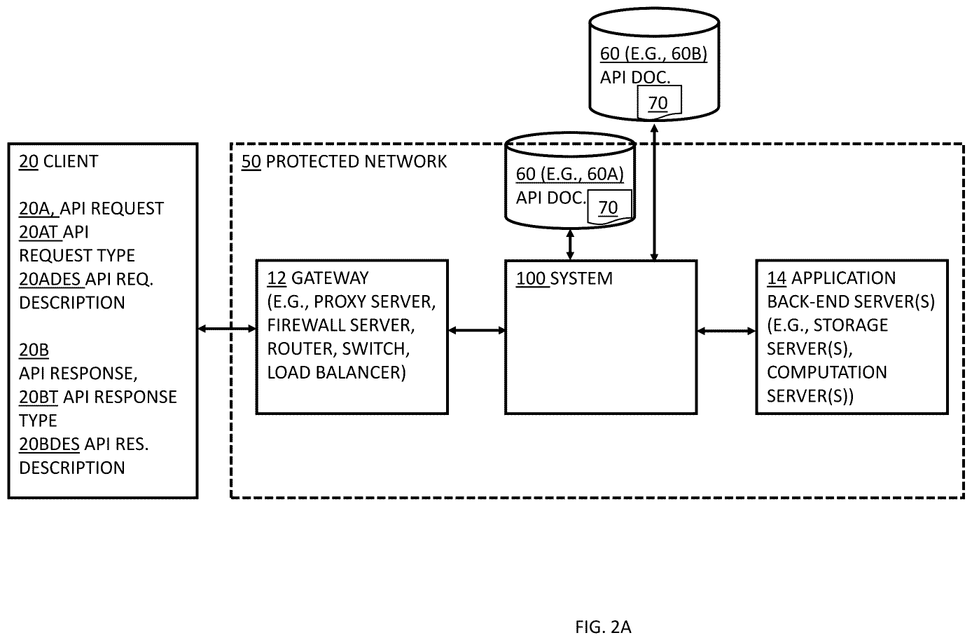

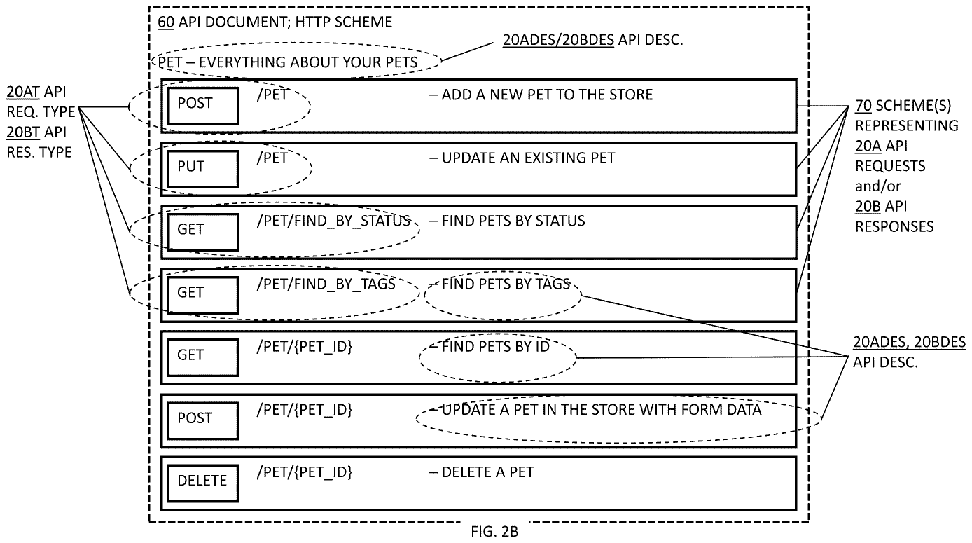

Reference is now made to FIG. 2A which is a block diagram, depicting application of a system 100 for providing zero-trust API security, according to some embodiments of the invention. According to some embodiments of the invention, system 100 may be implemented as a software module, a hardware module, or any combination thereof. For example, system 100 may be or may include a computing device such as element 1 of FIG. 1, and may be adapted to execute one or more modules of executable code (e.g., element 5 of FIG. 1) to provide zero-trust API security, as further described herein.

In some embodiments, system 100 may be, or may include a server computing device, or a proxy-server computing device, adapted to provide API security for an on-premises, or virtual private network, also denoted herein as “protected network 50”. System 100 may, for example, be implemented on an on-premises computing device (e.g., local to protected network 50), on a distributed computing device (e.g., cloud-based) or any other processing device.

Additionally, or alternatively, system 100 may be installed on, integrated with, or associated with one or more computer-network components or modules 12 such as a gateway module, a router module, a switch module, a load balancer module, a firewall module, and the like.

According to some embodiments, system 100 may receive an API documentation data element 60 (or API document 60, for short) that may define or describe (e.g., include a description 20ADES of) one or more types 20AT of API requests 20A, as elaborated herein. For example, system 100 may include an API security administrative user interface (UI), such as input element 7 of FIG. 1, and may receive API document 60 via UI 7.

Additionally, or alternatively, system 100 may receive a link to such API documentation data element 60, that may be stored (e.g., on storage device 6 of FIG. 1) within protected network 50 (denoted as element 60A) or beyond protected network 50 (denoted as element 60B).

It may be appreciated that API requests 20A may be configured to produce corresponding API responses 20B. In this context, API document 60 may also include definitions or descriptions 20BDES of one or more types 20BT of API responses 20B, as elaborated herein.

It may be appreciated that embodiments of the invention may not be limited to any specific type or standard of API documentation. System 100 may be configured or adapted according to any specific API documentation standard, to parse API document 60, so as to create one or more scheme data elements 70 (or “schemes” for short). The one or more (e.g., each) scheme data elements 70 may include at least one definition or description 20ADES for utilizing a corresponding API request 20A type 20AT and/or a corresponding API response 20B type 20BT.

For example, a definition 20ADES for utilization of an API request 20A type 20AT may include definitions of, and/or limitations on one or more fields of the API request 20A type 20AT. In another example, a definition for utilization of an API request type 20AT may include definitions of and/or limitations on one or more applicable or allowable values of fields of the API request type 20AT.

Additionally, or alternatively, system 100 may receive or extract the one or more scheme data elements 70 directly from storage device 6 of FIG. 1 and/or UI 7.

Reference is now made to FIG. 2B which is a schematic diagram depicting a visualization of content of an API documentation data element 60, as known in the art. As shown in the example of FIG. 2B, API document 60 may include a description 20ADES of a plurality of API request 20A types 20AT. In this example, the API request 20A types 20AT include a first type (“POST/pet”) for adding a new pet to a pet store, a second type (“PUT/pet”) for updating an existing pet, a third type (“GET/pet/findBy Status”) for finding a pet according to their status, etc.

Additionally, and as known in the art, API documentation data element 60 may include some API requests 20A that are overloaded. As used herein, the term “type” may refer to a singular implementation of possibly overloaded API requests 20A. In this example, the API request 20A (“PUT/pet”) may be overloaded in a sense that it may include two API request types 20AT: a global API request type 20AT (“PUT/pet”) for adding a pet to the store, and a particular API request type 20AT (“PUT/pet/{pet_id}”) for adding a pet having a specific ID to the store.

The API documentation data element 60 may follow or comply with any specific standard or syntax, e.g., a syntax of a scripting language and/or a standard of a data structure, to convey or include the information as depicted in the visualized example of FIG. 2B. System 100 may be adapted according to the relevant standard (e.g., the syntax of a scripting language and/or a standard of a data structure) to parse API document 60, so as to create one or more scheme data elements 70.

Scheme data elements 70 may include one or more data structures (e.g., tables), each including definitions 20ADES of fields and field values that define the one or more corresponding API request 20A types 20AT. In this example, a first scheme data element 70 may define the “POST/pet” API request 20A type, and may thus include a definition 20ADES of the API request 20A type's method (POST), and a required field for a pet's name (e.g., a character string). A second scheme data element 70 may define the “GET/pet/findByStatus” API request 20A type, and may thus include a definition 20ADES of the API request 20A type's method (GET), a required field representing the pet's status (e.g., an integer number), and definition 20BDES of an expected returned value (e.g., a character string, representing the pet's name) in a subsequent API response 20B.

As elaborated herein, system 100 may translate or associate one or more (e.g., each) API scheme 70 to a set of rules and/or limitations based on the field types and/or allowed values. It may be appreciated that these rules may associate between specific API requests and corresponding actions (e.g., filtration actions), to implement a predefined policy. Therefore, in this context, the terms “rules” and “policy” may be used herein interchangeably.

Pertaining to the “GET/pet/findByStatus” example, system 100 may produce: (a) a first rule or policy, limiting the input type for this method (e.g., integer number corresponding to the ‘status’ field) in API request 20A; (b) a second rule or policy, limiting the input value for this method (e.g., integer number in the range of [1-100], not including letters or special characters) in API request 20A; (c) a third rule or policy, limiting the type of an expected returned value (e.g., a string, representing the pet's name) in a subsequent API response 20B; and (d) a fourth rule or policy, limiting properties of the returned value (e.g., limiting the field to 10 letter characters, disallowing numbers and special characters) in API response 20B.

According to some embodiments, system 100 may receive an API request 20A to access a computing device on a protected computer network from one or more computing devices, denoted herein as client devices 20, which may be included in (e.g., in the same network domain as) protected network 50, or external or beyond protected network 50 (as shown in FIG. 2A). For example, API request 20A may include a request to access (e.g., read access, write access, delete, etc.) one or more application back-end servers 14 such as storage server(s) or computation server(s) included in protected network 50.

System 100 may associate the received API request 20A to a corresponding scheme 70 of the one or more first schemes, based on a type of the received API request. Pertaining to the example depicted in FIG. 2B, system 100 may receive a “PUT/pet” API request 20A, and may associate the received instance of API request 20A to a scheme 70 that corresponds to the specific type (e.g., “PUT/pet/” or “PUT/pet/{pet_id}”) of this overloaded API request 20A.

As elaborated herein, system 100 may subsequently filter the received API request 20A based on the associated scheme. In other words, system 100 may apply one or more limitations on the received API request 20A, according to rules associated with the schemes of the received API request 20A.

Additionally, or alternatively, system 100 may attribute one or more filtration actions 114B to at least one API request 20A or API request type, and may filter the received API request 20A by applying the one or more filtration actions 114B to the received API request 20A, based on the associated scheme 70.

For example, system 100 may examine the received instance of API request 20A in view of the corresponding one or more rules. System 100 may subsequently: (a) apply a first filtration action (e.g., forward the received API request 20A to back-end server 14) if API request 20A complies to the relevant rule; or (b) apply a second filtration action (e.g., block the received API request 20A) if API request 20A does not comply to the relevant rule.

It may be appreciated that system 100 may collaborate with additional (e.g., trust-based) methods and logic for enhancing cyber-security on protected network 50. For example, system 100 may complement the function of machine-learning (ML) based solutions, which are directed to learn a structure or pattern of legitimate or illegitimate API requests 20A and responses 20B.

For example, system 100 may be configured to compute metrics representing features of monitored API requests 20A and responses 20B. System 100 may utilize these metrics as a stand-alone computing device, to enrich learning of structures or patterns of legitimate or illegitimate API requests 20A and responses 20B. Additionally, or alternatively, system 100 may be configured to transmit the calculated metrics to another computing device, such as a data lake server or an Artificial Intelligence (AI) engine server as enriched data, to learn the structures or patterns of legitimate or illegitimate API requests 20A and responses 20B.

In another example, system 100 may provide an immediate, and strict layer of security, by enforcing a zero-trust cyber-security methodology, to complement ML-based systems that may only provide an effective cyber-security layer after completing a learning curve.

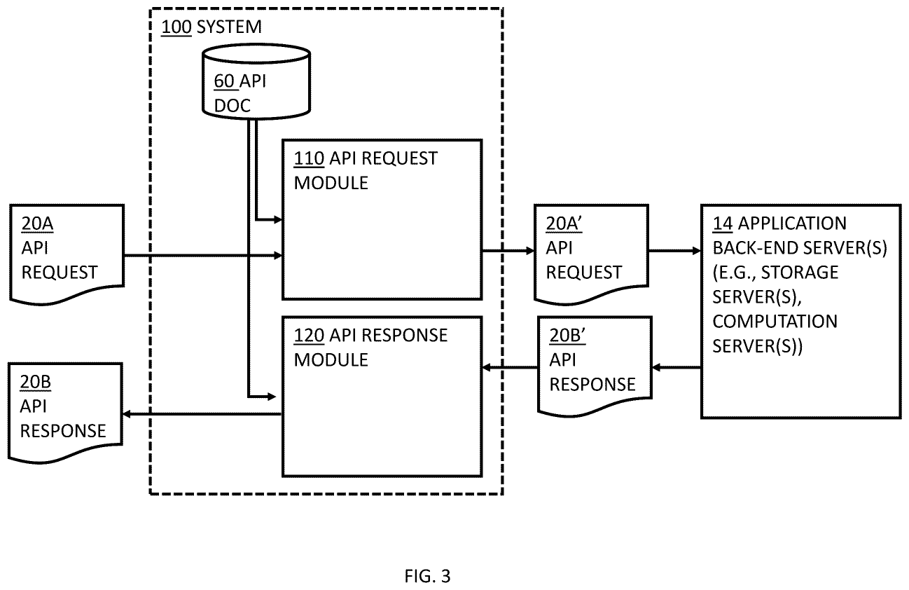

Reference is now made to FIG. 3, which is a block diagram, depicting a system 100 for providing zero-trust API security, according to some embodiments of the invention. System 100 of FIG. 3 may be the same as system 100 of FIG. 2.

As shown in FIG. 3, arrows may represent flow of one or more data elements to and from system 100 and/or among modules or elements of system 100. Some arrows have been omitted in FIG. 3 for the purpose of clarity.

As shown in FIG. 3, system 100 may include an API request module 110. As elaborated herein, API request module 110 may be adapted to receive an instance of an API request 20A; analyze the received API request 20A in view of API document 60 (e.g., in view of scheme 70); optionally filter the received API request 20A based on the analysis; and optionally transfer a filtered version 20A′ of received API request 20A to back-end server 14.

Back-end server 14 may, in turn, be configured to handle API request 20A (e.g., as received from client 20) or filtered version 20A′ (e.g., from API request module 110), and produce an API response 20B′, as known in the art.

Additionally, or alternatively, system 100 may include an API response module 120. As elaborated herein, API response module 120 may be adapted to receive API response 20B′ (e.g., from back-end server 14); analyze the received API response 20B′ in view of API document 60 (e.g., in view of scheme 70); optionally filter the received API response 20B′ based on the analysis; and optionally transfer a filtered version 20B of API response 20B′ to the relevant client 20.

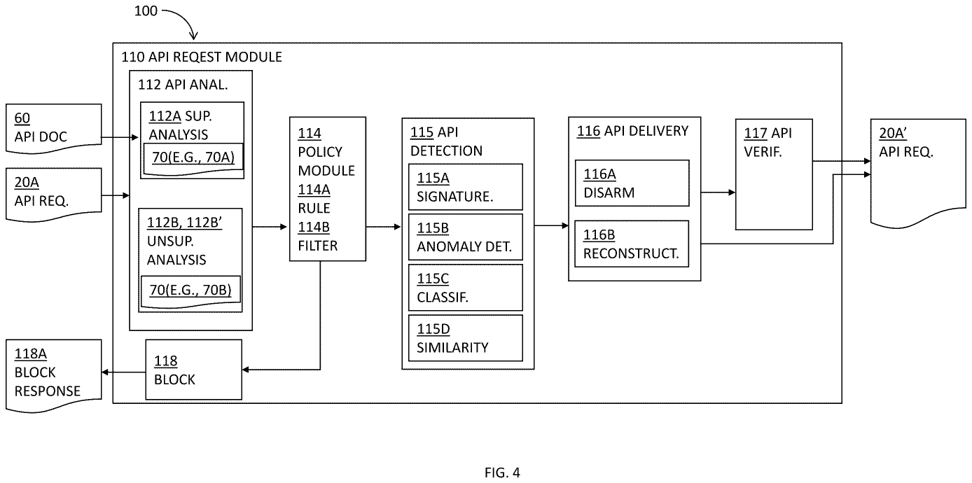

Reference is now made to FIG. 4 which is a block diagram, depicting an example of an aspect of system 100 for providing zero-trust API security, according to some embodiments of the invention. System 100 of FIG. 4 may be the same as system 100 of FIG. 2 and/or FIG. 3. It may be appreciated that the example depicted in FIG. 4 may be focused on the functionality of API request module 110. Some elements of system 100 have been omitted from FIG. 4 for the purpose of clarity.

As elaborated herein (e.g., in relation to FIG. 2A and/or FIG. 3), API request module 110 may receive (e.g., via a network communication component such as a router, a switch, a load-balancer, a firewall security module, and the like) an API request 20A, from at least one client 20, to access a computing device on a protected computer network.

As shown in FIG. 4, API request module 110 may include an API analysis module 112, adapted to produce or obtain at least one scheme data element 70, and analyze API request 20A according to the at least one scheme data element 70.

According to some embodiments, API analysis module 112 may include a supervised analysis module 112A, configured to produce or obtain scheme data element 70 from API document 60, as elaborated herein (e.g., in relation to FIG. 2B). In other words, supervised analysis module 112A may be configured to receive an API documentation data element 60, describing (e.g., including a description 20ADES of) one or more types 20AT of API requests 20A, and parse the API documentation data element 60, to create one or more schemes 70, each including one or more definitions 20ADES for utilization of a corresponding API request 20A type 20AT. The term “supervised” may be used in this context to indicate that creation of schemes 70 may be performed in accordance with supervisory data (in this example-documentation data element 60).

Additionally, or alternatively, API analysis module 112 may include an unsupervised analysis module 112B, configured to produce or obtain one or more scheme data elements 70 in an unsupervised manner. The term “unsupervised” may be used in this context to indicate that creation of schemes 70 may be performed in a manner that does not include labeled or annotated supervisory data.

According to some embodiments, unsupervised analysis module 112B may be, or may include a machine-learning (ML) based model 112B′, such as a clustering model.

As elaborated herein, unsupervised analysis module 112B may apply ML model 112B′ on at least one instance of an API request 20A, to obtain a utilization scheme 70B that may include one or more definitions 20ADES for content of fields of the received API request. Unsupervised analysis module 112B may associate the instance of an API request 20A to utilization scheme 70B, and subsequently filter (e.g., apply a filtering action) on the received API request 20A according to utilization scheme 70B.

During a training phase, system 100 may apply ML model 112B′ on a plurality of received API requests, to learn at least one utilization scheme or pattern 70 (e.g., 70B) of the plurality of received API requests 20A. The utilization scheme or pattern 70B may include one or more definitions 20ADES/20BDES for utilization of fields of the received API request 20A, as elaborated herein.

In other words, during a training stage, system 100 may receive a plurality of API requests 20A, corresponding to a respective plurality of API request types 20AT. For at least one (e.g., each) API request type 20AT, system 100 may train ML model 112B′ to cluster the corresponding plurality of API requests 20A to one or more clusters, based on type and/or content of fields of the API requests 20A. Pertaining to the example of FIG. 2B, each such cluster may represent, or include API requests 20A of a specific API request type 20AT (e.g., “POST/pet”, “PUT/pet”, “GET/pet/findByStatus”, etc.).

Additionally, or alternatively, for at least one (e.g., each) cluster, unsupervised analysis module 112B may associate or attribute a specific utilization scheme 70 (e.g., 70B). Utilization scheme 70B may include, or may represent one or more definitions 20ADES for utilization of fields of the corresponding API requests 20A. In other words, each scheme 70B may include definitions 20ADES for fields of API requests 20A, of an API request type 20AT that corresponds to the relevant cluster.

Additionally, or alternatively, API analysis module 112 may analyze a received API request 20A in view of utilization scheme 70 (e.g., 70A, 70B). For example, API analysis module 112 may parse the received API request 20A, and associate the received API request 20A to a specific scheme 70A as elaborated herein (e.g., in relation to FIG. 2B). In another example, API analysis module 112 may parse the received API request 20A, to identify an API request type 20AT of the received API request 20A, and then associate the received API request 20A to a specific cluster (and a corresponding scheme 70) that represents the identified API request type 20AT.

As shown in FIG. 4, API request module 110 may include a policy module 114, configured to filter the received API request 20A based on the associated scheme. In other words, policy module 114 may apply at least one rule 114A on a received API request 20A, according to utilization scheme 70 (e.g., 70A and/or 70B), to apply a filtration action 114B on the relevant API request 20A.

For example, supervised analysis module 112A may associate one or more filtration actions 114B to at least one scheme 70A (which may represent one or more specific API request types 20AT). Analysis module 112A may then identify a condition in which the received API request 20A is non-compliant with utilization scheme 70A. Such non-compliance may include, for example, having API fields and/or field values that exceed, or deviate from fields and/or field values as defined by a definition 20ADES/20BDES of utilization scheme 70 (e.g., 70A). Supervised analysis module 112A may then collaborate with policy module 114 to apply the one or more associated filtration actions 114B on the received API request 20A, based on the identification of non-compliance.

In another example, unsupervised analysis module 112B may associate one or more filtration actions 114B to at least one cluster of clustering model 112B′ (which may represent a scheme 70B of one or more specific API request type 20AT). Analysis module 112B may then identify a condition in which the received API request 20A is non-compliant with utilization scheme 70B of the relevant cluster, as explained above. Unsupervised analysis module 112B may subsequently collaborate with policy module 114 to apply the one or more associated filtration actions 114B on the received API request 20A, based on the identification of non-compliance.

As explained herein, scheme 70 (e.g., 70A, 70B) may be obtained by zero-trust methodology. Embodiments of the invention rules may provide rules 114A and/or filtration actions 114B that implement an API security policy, based on the obtained zero-trust schemes 70. It may therefore be appreciated by a person skilled in the art that rules 114A and/or filtration actions 114B may provide an improvement over currently available systems and methods of API security, which are not based on zero-trust methodology.

As elaborated herein, rules 114A may be, or may include a data structure (e.g., a table) that may associate between at least one scheme 70 and one or more respective filtration actions 114B that may be applied to relevant API requests 20A.

For example, a rule 114A may dictate that policy module 114 may apply a filtration action 114B such as transferring of a received API request 20A to a computing device of the protected computer network, such as application back-end server 14 of FIG. 3.

In another example, a rule 114A may dictate that policy module 114 may apply a filtration action 114B such as transferring of a received API request 20A to a subsequent security module of system 100, such as API detection module 115, as elaborated herein.

In another example, a rule 114A may dictate that policy module 114 may apply a filtration action 114B such as blocking the received API request 20A so as to disallow API request 20A from reaching the computing device (e.g., computing device 14 of FIG. 3) of the protected computer network. In such embodiments, a blocking module 118 may issue a block response 118A, notifying the relevant client 20 of the blocking action.

In another example, a rule 114A may dictate that policy module 114 may apply a filtration action 114B such as disarming the received API request 20A. In such embodiments, policy module 114 may transmit, or forward API request 20A to a disarm module 116A, adapted to further analyze API request 20A, so as to identify or detect malicious, unexpected, or disallowed content in API request 20A. The term “disarm” may be used in this context to indicate detection of a harmful, malicious, or disallowed field, field content or field value (e.g., an anomalous or unauthorized value) in API request 20A.

In another example, policy module 114 may apply a filtration action 114B such as reconstructing the received API request 20A. The term “reconstructing” may be used in this context to indicate modification or edition of API request 20A, to produce legitimate version 20A′ of API request 20A. Such modification may include, for example modification of a value of a field in API request 20A, deletion of content (e.g., a string) or a portion of a content (e.g., a portion of a string) of a field in API request 20A, omission of a field in API request 20A, and the like.

In such embodiments, policy module 114 may transmit, or forward API request 20A to a reconstruction module 116B. According to some embodiments, reconstruction module 116B may collaborate with disarm module 116A to reconstruct API request 20A, and produce legitimate version 20A'. For example, disarm module 116A may identify or detect malicious content in API request 20A as elaborated herein, and reconstruction module 116B may modify or omit the malicious content, so as to produce a legitimate version 20A′ of API request 20A, which does not include the malicious content. Reconstruction module 116B may subsequently transfer legitimate version 20A′ of received API request 20A to a computing device (e.g., application back-end server 14 of FIG. 3) of protected computer network 50.

According to some embodiments, different entities and/or modules of system 100 may be included in, or implemented by the same computing platforms, allowing the various functions described herein to be performed by a single computing device (e.g., computing device 1 of FIG. 1). For example, a single computing device 1 may facilitate the functionality of API analysis module 112, and the functionality of disarm 116A and/or reconstruction modules 116B. Additionally, or alternatively, entities and/or modules of system 100 may be distributed among, or implemented by different, communicatively connected computing devices 1.

As shown in FIG. 4, API request module 110 may include an API verification module 117, adapted to ensure that legitimate version 20A′ of API request 20A is compliant with API definitions 20ADES included in scheme 70.

For example, as elaborate herein, reconstruction module 116B may modify API request 20A (e.g., omit or delete an API field content), to produce legitimate version 20A′. If legitimate version 20A′ is now non-compliant with a definition 20ADES of API request 20A, as defined 20ADES by scheme 70 (e.g., missing a field in the API, following reconstruction of API request 20A), then API verification module 117 may block API request version 20A′, or disallow transmission of API request version 20A′ to application back-end server 14. In a complementary manner, if legitimate version 20A′ is still compliant (API request 20A) with a definition 20ADES of API request 20A, as defined 20ADES by scheme 70, then API verification module 117 may enable or allow transmission of API request version 20A′ to application back-end server 14.

As shown in FIG. 4, API request module 110 may include or may be associated with one or more API detection modules 115 (e.g., 115A, 115B, 115C, 115D), configured to provide additional aspects of cyber security in relation to the received API request 20A.

For example, API detection module 115 may include a signature module 115A, adapted to verify a signature that is included in, or associated with an API request 20A, sent by a specific client 20, as known in the art.

In another example, API detection module 115 may include an anomaly detection module 115B, adapted to identify any type of anomaly from associated with API request 20A.

For example, anomaly detection module 115B maybe, or may include an ML-based model, adapted to learn and/or identify anomalies in API request 20A based on single user or multiple user activities. Such anomalies can be learned based on univariate or multivariate data features that can be driven from a single API request 20A event or API request 20A field. Additionally, or alternatively, the anomalies can be learned based on univariate or multivariate data features that can be driven from multiple API request 20A events or API request 20A fields. For example, anomaly detection module 115B may trigger an anomaly based on an abnormal API request 20A usage frequency or abnormal API request 20A content.

Anomaly detection module 115B may report any detected anomaly as an event based on its severity. Additionally, or alternatively, anomaly detection module 115B may aggregate a plurality of anomalies to increase a confidence of the reported alert.

In another example, API detection module 115 may include a classification module 115C, which may be, or may include a supervised or semi-supervised ML-based classification model. Classification module 115C may be trained to classify singular events and/or a plurality of events based on data labeling of known events. Such classification may be done on different types of information domains such as API request content, one or more users'historical behavior, and the like.

According to some embodiments, the ML based models of classification module 115C may be applied to tabular (e.g., feature-based) information. Additionally, or alternatively, the ML based models of classification module 115C may be applied to textual information. In such embodiments, classification module 115C may apply information vector embedding (e.g., word or character-based embedding) on API request 20A to handle the text, and classify API request 20A (e.g., using a deep learning methodology).

In yet another example, API detection module 115 may include a similarity module 115D, adapted to establish similarity of information pertaining to received API requests to that of well-known API attacks.

For example, similarity module 115D may compare one or more fields of API request 20A to patterns of known attacks based on string compare (distance-based) or string vector embedding similarity metrics. Similarity module 115D may subsequently identify at least on API request as relating to a known API attack. Similarity module 115D may thus detect evasive API attacks based on known vulnerabilities or past API attacks.

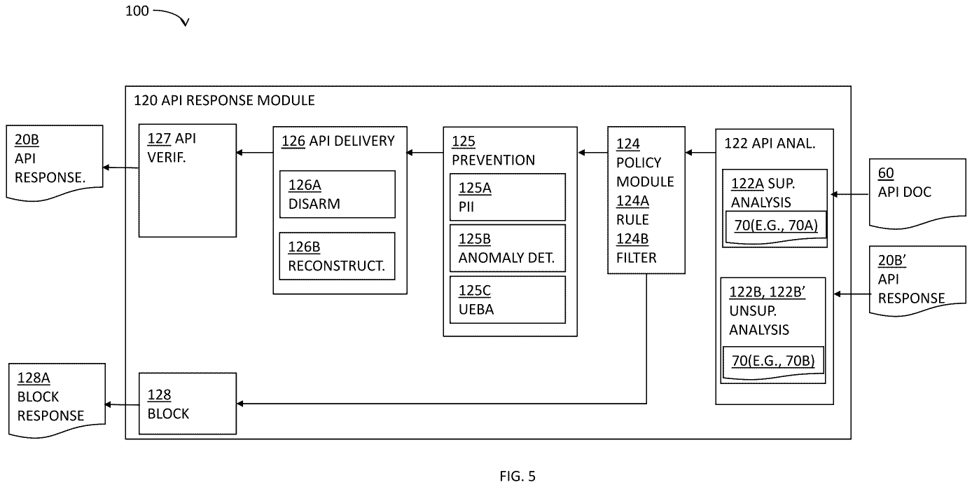

Reference is now made to FIG. 5 which is a block diagram, depicting an example of an aspect of system 100 for providing zero-trust API security, according to some embodiments of the invention. System 100 of FIG. 5 may be the same as system 100 of FIGS. 2, 3 and/or 4. It may be appreciated that the example depicted in FIG. 5 may be focused on the functionality of API response module 120. Some elements of system 100 have been omitted from FIG. 5 for the purpose of clarity.

As elaborated above (e.g., in relation to FIGS. 3, 4), system 100 may include an API request module 110, adapted to apply API security on API requests, e.g., received from client 20 en route application back-end servers 14. It may be appreciated that API response module 120 may include similar sub-modules and functions that may apply API security on API responses 20B′, e.g., received from back-end servers 14 en route relevant clients 20.

In other words, API response module 120 may include sub-modules such as elements 122, 124, 125, 126, 127 and 128 of FIG. 5, that may be applied on API responses 20B′ to provide the required API security. Elements 122, 124, 125, 126, 127 and 128 of API response module 120 may be similar in functionality to sub-modules 112, 114, 115, 116, 117 and 118 of API request module 110, respectively. The description of sub-modules 122, 124, 125, 126, 127 and 128 will therefore not be fully repeated here, for the purpose of brevity.

As shown in FIG. 5, API response module 120 may include an API analysis module 122. API analysis module 122 may apply similar functions on API responses 20B′ as the function of API analysis module 112 applied on API requests 20A. The description of sub-module 122 will therefore not be fully repeated here, for the purpose of brevity.

According to some embodiments, API analysis module 122 may be adapted to produce or obtain at least one scheme data element 70 (e.g., 70A, 70B). API analysis module 122 may produce or obtain scheme data element 70 in relation to API response 20B′ in a similar manner to that of API analysis module 112 (in relation to for API request 20A), as elaborated herein (e.g., in relation to FIG. 4).

API analysis module 122 may subsequently analyze API response 20B′ according to the at least one scheme data element 70, in a similar manner to that of API analysis module 112 (in relation to for API request 20A), as elaborated herein (e.g., in relation to FIG. 4).

According to some embodiments, API analysis module 122 may include a supervised analysis module 122A that may be similar to supervised analysis module 112A of FIG. 4. Supervised analysis module 122A may be configured to produce or obtain scheme data element 70 from API document 60, as elaborated herein in relation to API analysis module 112. For example, supervised analysis module 122A may be configured to receive an API documentation data element 60, describing (e.g., including a description or definition 20BDES of) one or more types 20BT of API responses 20B', and parse the API documentation data element 60, to create one or more schemes 70. Each scheme 70 may include one or more definitions 20BDES for utilization of a corresponding API response 20B type 20BT.

Additionally, or alternatively, API analysis module 122 may include an unsupervised analysis module 122B, that may be similar to unsupervised analysis module 112B of FIG. 4. Unsupervised analysis module 122B may be configured to produce or obtain one or more scheme data elements 70 in an unsupervised manner, as elaborated herein in relation to unsupervised analysis module 112B.

According to some embodiments, unsupervised analysis module 122B may include an ML model 122B′ that may be similar to ML model 112B′ of FIG. 4. Unsupervised analysis module 122B may apply ML model 122B′ on at least one instance of an API response 20B′, as elaborated herein. Unsupervised analysis module 122B may thus obtain a utilization scheme 70B that may include one or more definitions 20BDES for content of fields of the received API response 20B′. Unsupervised analysis module 122B may associate the instance of an API response 20B′ to utilization scheme 70B, to subsequently filter (e.g., apply a filtering action) on the received API response 20B′ according to utilization scheme 70B.

As shown in FIG. 5, API response module 120 may include a policy module 124, that may be similar to policy module 114 of FIG. 4. According to some embodiments, policy module 124 may be configured to filter the received API response 20B′ based on an associated scheme. In other words, policy module 124 may apply at least one rule 124A on a received API response 20B′, according to utilization scheme 70 (e.g., 70A and/or 70B), to apply a filtration action 124B on the relevant API response 20B.

For example, supervised analysis module 112A may associate one or more filtration actions 124B to at least one scheme 70A (which may represent one or more specific API response types 20BT). Analysis module 122A may then identify a condition in which a received API response 20B′ is non-compliant with utilization scheme 70A. Such non-compliance to rule 124A may include, for example having API fields and/or field values that exceed, or deviate from fields and/or field values as defined (20ADES/20BDES) by utilization scheme 70 (e.g., 70A). In another example, non-compliance with rule 124A may include existence of personal or confidential data within response 20B'. In another example, non-compliance to rule 124A may include a condition in which an API request 20A does not match a structure, content or data volume of a subsequent, corresponding response 20B'.

According to some embodiments, supervised analysis module 122A may subsequently collaborate with policy module 124 to apply the one or more associated filtration actions 124B on the received API response 20B, based on the identification of non-compliance.

For example, in reaction to identification of non-compliance to rule 124A, policy module 124 may apply one or more filtration actions 124B. Filtration actions 124B may include, for example transferring response 20B′ of computing device 14 of protected computer network 50 to the received API request 20A, blocking response 20B′ of computing device 14 of network 50 to the received API request 20A, disarming response 20B′ of the computing device 14 of network 50 to the received API request 20A, reconstructing a response 20B′ of computing device 14 of the protected computer network 50 to the received API request 20A, and producing and/or presenting an alert regarding non-compliance to rule 124A on one or more computing devices (e.g., client 20).

As elaborated herein, API response module 120 may include an API delivery module 126, which may be similar to API delivery module 116 of FIG. 4. As elaborated herein, rule 124A may dictate that policy module 124 may apply a filtration action 124B such as disarming the received API response 20B′. In such embodiments, policy module 124 may transmit, or forward API response 20B′ to a disarm module 126A, adapted to further analyze API response 20B′ so as to identify or detect malicious, unexpected, or disallowed content in API response 20B′. The term “disarm” may be used in this context to indicate detection of a harmful, malicious, or disallowed field, field content or field value (e.g., an anomalous or unauthorized value) in API response 20B′.

Additionally, or alternatively, policy module 124 may apply a filtration action 124B such as reconstructing the received API response 20B′. The term “reconstructing” may be used in this context to indicate modification or edition of API response 20B′, to produce legitimate version 20B of API response 20B′. Such modification may include, for example modification of a value of a field in API response 20B′, deletion of content (e.g., a string) or a portion of a content (e.g., a portion of a string) of a field in API response 20B′, omission of a field in API response 20B′, and the like.

In such embodiments, policy module 124 may transmit, or forward API response 20B′ to a reconstruction module 126B. According to some embodiments, reconstruction module 126B may collaborate with disarm module 126A to reconstruct API response 20B′, and produce legitimate version 20B. For example, disarm module 126A may identify or detect malicious content in API response 20B′ as elaborated herein, and reconstruction module 126B may modify or omit the malicious content, so as to produce a legitimate version 20B of API response 20B′, which does not include the malicious content. Reconstruction module 126B may subsequently transfer legitimate version 20B of received API response 20B′ to a computing device (e.g., client 20).

As shown in FIG. 5, API response module 120 may include an API verification module 127 that may be similar to API verification module 117 of FIG. 4. According to some embodiments, API verification module 127 may be adapted to ensure that legitimate version 20B of API response 20B′ is compliant with API definitions 20BDES included in scheme 70.

For example, as elaborate herein, reconstruction module 126B may modify API response 20B′ (e.g., omit or delete an API field content), to produce legitimate version 20B. If legitimate version 20B is now non-compliant with a definition 20BDES of API response 20B′, as defined by scheme 70 (e.g., missing a field in the API, following reconstruction of API request 20A), then API verification module 127 may block API response version 20B, or disallow transmission of API response version 20B to client 20. In a complementary manner, if legitimate version 20B is still compliant with a definition 20BDES of API response 20B′ as defined by scheme 70, then API verification module 127 may enable or allow transmission of API response version 20B to client 20.

As shown in FIG. 5, API response module 120 may include a block module 128 which may be similar to block module 118 of FIG. 4. According to some embodiments, a rule 124A may dictate that policy module 124 may apply a filtration action 124B such as blocking the received API response 20B′ so as to disallow API response 20B′ from reaching the computing device (e.g., client 20). In such embodiments, blocking module 128 may issue a block response 118A (e.g., disallow transfer of API response 20B′ to client 20), and may notify the relevant computing device (e.g., client 20) of the blocking action.

As shown in FIG. 5, API response module 120 may include, or may be associated with one or more API prevention modules 125 (e.g., 125A, 125B, 125C), configured to provide additional aspects of cyber security in relation to the received API response 20B'.

For example, API prevention modules 125 may include a Personal Identifiable Information (PII) module 125A, adapted to identify any type of data included in API response 20B′ that could potentially identify a specific individual. For example, PII module 125A may identify a username, a physical address, an email account, a telephone number, a date of birth, a passport number, a fingerprint, a driver's license number, a credit card number, a social security number, or any other sensitive information, which may be used for fraudulent activity. It may be appreciated that PII information in response 20B′ may be legitimate, but may also be included in response 20B′ as part of suspicious activity, e.g., indicating an API attack. PII module 125A may be configured to identify a types of PII that may be included in in response 20B′, and quantity a risk score, representing a probability that the PII of the identified type is indeed anomalous or malicious in the context of the current response 20B′ or response type 20BT.

In another example, API detection module 125 may include an anomaly detection module 125B, adapted to identify any type of anomaly associated with API response 20B′.

For example, anomaly detection module 125B may be, or may include an ML-based model, adapted to learn and/or identify anomalies in API response 20B′ based on single user or multiple user activities. Such anomalies can be learned based on univariate or multivariate data features that can be driven from a single API response 20B′ event or from an API response 20B′ field.

Additionally, or alternatively, anomaly detection module 125B may learn the anomalies based on univariate or multivariate data features that can be driven from multiple API response 20B′ events and/or API request 20A fields. For example, anomaly detection module 125B may trigger an anomaly based on an abnormal API response 20B′ usage frequency or abnormal API response 20B′ content.

Additionally, or alternatively, anomaly detection module 125B may report any detected anomaly as an event based on its severity. Anomaly detection module 125B may aggregate a plurality of anomalies to increase a confidence of the reported alert.

In another example, API detection module 125 may include a User and Entity Behavior Analytics (UEBA) module 125C. As known in the art, the term UEBA (also known as User Behavior Analytics (UBA) may refer to a process of gathering insight into the network events that users routinely generate. According to some embodiments, UEBA module 125C can detect and alert against the threats that originate from external sources, rather than being limited to detection of threats originating from individual users. Such external sources may include, but are not limited to, bots, routers, servers, applications, and other network devices that may be employed by a perpetrator to compromise or attacking an API of an application server 14 in a distributed manner. UEBA module 125C may be configured to use AI and ML to detect anomalous activity originating from multi-users'perspective who may consume the same API or group of API's. UEBA module 125C may subsequently perform a mitigating action, such as producing a notification, alerting against the suspected UEBA event, and/or blocking detected suspicious or anomalous entity behaviors.

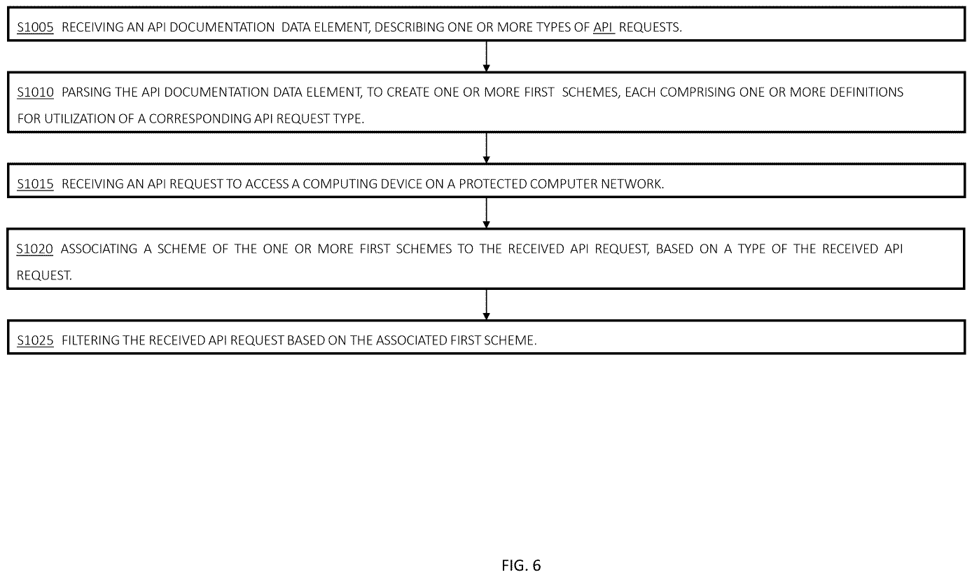

Reference is now made to FIG. 6 which is a flow diagram, depicting a method of providing zero-trust API security by at least one processor (e.g., processor 2 of FIG. 1), according to some embodiments of the invention.

As shown in step S1005, the at least one processor 2 may receive an API documentation data element (e.g., API document 60 of FIGS. 3, 4 and/or 5), describing (e.g., including a description 20ADES of) one or more types 20AT of API requests 20A and/or one or more types 20BT of API responses 20B.

As shown in step S1010, the at least one processor 2 may parse API documentation data element 60, to create one or more schemes 70 (e.g., 70A, 70B). Each scheme may include one or more definitions 20ADES/20BDES for utilization of a corresponding API request type 20AT and/or API response type 20BT, respectively;

As shown in step S1015, the at least one processor 2 may receive (e.g., from a computing device such as client 20 of FIG. 2A) an API request 20A to access a computing device (e.g., an applications server 14 of FIG. 2A) on a protected computer network (e.g., network 50 of FIG. 2A).

As shown in steps S1020 and S1025, the at least one processor 2 may associate a scheme 70 of the one or more schemes to the received API request 20A, based on a type 20AT of the received API request 20; and may subsequently filter the received API request 20A, and/or a response 20B′ to API request 20A, based on the associated scheme, as elaborated herein.

As elaborated herein, embodiments of the invention may provide a practical application by improving a functionality or security of a computer network.

For example, embodiments of the invention may implement a novel, zero-trust approach to cyber security, which may limit an organizational computer network vulnerability to API attack vectors. As explained herein, scheme 70 (e.g., 70A, 70B) may be obtained by zero-trust methodology, allowing embodiments of the invention to provide rules 114A and/or filtration actions 114B that implement an API security policy, based on the obtained zero-trust schemes 70. It may therefore be appreciated by a person skilled in the art that rules 114A and/or filtration actions 114B may provide an improvement over currently available systems and methods of API security, which are not based on zero-trust methodology.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of providing Application Programming Interface (API) security by at least one processor, the method comprising:
receiving an API documentation data element, describing one or more types of API requests;
parsing the API documentation data element, to create one or more first schemes, each comprising one or more definitions for utilization of a corresponding API request type;
receiving an API request to access a computing device on a protected computer network;
associating a scheme of the one or more first schemes to the received API request, based on a type of the received API request; and
filtering the received API request based on the associated first scheme.

2. The method of claim 1, wherein the definition for utilization of an API request type comprises definitions of one or more fields of the API request type and one or more applicable values of these fields.

3. The method of claim of claim 1, further comprising attributing one or more filtration actions to at least one API request type, and wherein filtering the received API request comprises applying the one or more filtration actions to the received API request, based on the associated scheme.

4. The method of claim 3, wherein the filtration actions are selected from a list consisting of: transferring the API request to the computing device of the protected computer network, blocking the received API request, disarming the received API request, reconstructing the received API request, transferring a response of the computing device of the protected computer network to the received API request, blocking the response of the computing device of the protected computer network to the received API request, disarming a response of the computing device of the protected computer network to the received API request, and reconstructing a response of the computing device of the protected computer network to the received API request.

5. The method of claim of claim 1, further comprising:
applying a machine-learning (ML) based model on the received API request, to obtain at least one second utilization scheme, comprising one or more definitions for utilization of fields of the received API request; and
filtering the received API request according to the second utilization scheme.

6. The method of claim 5, further comprising, in a training stage:
receiving a plurality of API requests, corresponding to a respective plurality of API request types;
for at least one API request type, training the ML model to cluster the corresponding plurality of API requests to one or more clusters, based on content of fields of the API requests; and
for at least one cluster, associating a second utilization scheme, comprising one or more definitions for utilization of fields of the corresponding API requests.

7. The method of claim 6, wherein filtering the received API request according to the second utilization scheme comprises:
associating one or more filtration actions to at least one cluster;
identifying a condition in which the received API request is non-compliant with a second utilization scheme of the at least one cluster; and
applying the one or more filtration actions on the received API request, based on said identification.

8. A method of providing Application Programming Interface (API) security by at least one processor, the method comprising:
receiving an API request;
applying a machine-learning (ML) based model on the API request, to obtain a utilization scheme, comprising one or more definitions for content of fields of the received API request; and
filtering the received API request according to the utilization scheme.

9. The method of claim 8, further comprising, in a training stage:
receiving a plurality of API requests, corresponding to a respective plurality of API request types;
for at least one API request type, training the ML model to cluster the corresponding plurality of API requests to one or more clusters, based on content of fields of the API requests; and
for at least one cluster, associating a utilization scheme, comprising one or more definitions for utilization of fields of the corresponding API requests.

10. The method of claim 8, wherein filtering the received API request according to the utilization scheme further comprises:
associating one or more filtration actions to at least one cluster;
identifying a condition in which the received API request is non-compliant with a utilization scheme of the at least one cluster; and
applying the one or more filtration actions on the received API request, based on said identification.

11. A system for providing zero-trust API security, the system comprising: a non-transitory memory device, wherein modules of instruction code are stored, and a processor associated with the memory device, and configured to execute the modules of instruction code, whereupon execution of said modules of instruction code, the processor is configured to:
receive an API documentation data element, describing one or more types of API requests;
parse the API documentation data element, to create one or more first schemes, each comprising one or more definitions for utilization of a corresponding API request type;
receive an API request to access a computing device on a protected computer network;
associate a scheme of the one or more first schemes to the received API request, based on a type of the received API request; and
filter the received API request based on the associated first scheme.

12. The system of claim 11, wherein the definition for utilization of an API request type comprises definitions of one or more fields of the API request type and one or more applicable values of these fields.

13. The system of claim 11, wherein the at least one processor is further configured to:
attribute one or more filtration actions to at least one API request type; and
filter the received API request by applying the one or more filtration actions to the received API request, based on the associated scheme.

14. The system of claim 13, wherein the filtration actions are selected from a list consisting of: transferring the API request to the computing device of the protected computer network, blocking the received API request, disarming the received API request, reconstructing the received API request, transferring a response of the computing device of the protected computer network to the received API request, blocking the response of the computing device of the protected computer network to the received API request, disarming a response of the computing device of the protected computer network to the received API request, and reconstructing a response of the computing device of the protected computer network to the received API request.

15. The system of claim of claim 11, wherein the at least one processor is further configured to:
apply a machine-learning (ML) based model on the received API request, to obtain at least one second utilization scheme, comprising one or more definitions for utilization of fields of the received API request; and
filter the received API request according to the second utilization scheme.

16. The system of claim 15, wherein the at least one processor is further configured to, in a training stage:
receive a plurality of API requests, corresponding to a respective plurality of API request types;
for at least one API request type, train the ML model to cluster the corresponding plurality of API requests to one or more clusters, based on content of fields of the API requests; and
for at least one cluster, associate a second utilization scheme, comprising one or more definitions for utilization of fields of the corresponding API requests.

17. The system of claim 16, wherein the at least one processor is further configured to filter the received API request according to the second utilization scheme by:
associating one or more filtration actions to at least one cluster;
identifying a condition in which the received API request is non-compliant with a second utilization scheme of the at least one cluster; and
applying the one or more filtration actions on the received API request, based on said identification.

18. A system for providing Application Programming Interface (API) security, the system comprising: a non-transitory memory device, wherein modules of instruction code are stored, and a processor associated with the memory device, and configured to execute the modules of instruction code, whereupon execution of said modules of instruction code, the processor is configured to:
receive an API request;
apply a machine-learning (ML) based model on the API request, to obtain a utilization scheme, comprising one or more definitions for content of fields of the received API request; and
filter the received API request according to the utilization scheme.
